(19) United States
(12) Patent Application Publication
(10) Pub. No.: US 2003/0056843 A1
(43) Pub. Date: Mar. 27, 2003

(54) Pipe line blind

(76) Inventor: H.B. Carey, Edmonton, KY (US)

Correspondence Address: CARRITHERS LAW OFFICE, One Paragon Centre, Suite 140, 6060 Dutchman's Lane, Louisville, KY, 40205, US

(21) Appl. No.: 10/136,617

(22) Filed: May 1, 2002

Related U.S. Application Data
(60) Provisional application No. 60/287,983, filed on May 1, 2001.

(51) Int. Cl. F16L 55/10

(52) U.S. Cl. 138/94.3; 138/94

(57) ABSTRACT

A pipe blind in which a lug radiating there from and having a hole there through for one of the coupling bolts is of lesser thickness than the remainder of the plate and less than the thickness between juxtaposed faces of the flanges of the pipe coupling whereby the blind when not in use can remain suspended from one of the bolts of the coupling.

This application claims priority from U.S. Provisional application Serial No. 60/287,983 filed on May 1, 2001, and is hereby incorporated by reference.

### FIELD OF INVENTION

This invention relates generally to high pressure pipelines and more particularly to an improved blind.

### BACKGROUND OF THE INVENTION

Various types of blinds are known in the art and are used to completely stop the flow to a piece of equipment and thus isolate it from the system so that servicing operations or replacement of the equipment can take place.

The blind which is the subject of the present invention maybe in the form of a FIG. 8 as seen in FIG. 3 of U.S. Pat. No. 2,566,585 granted Sep. 4, 1951 to P. C. Livesay; FIG. 3 of U.S. Pat. No. 4,343,332 granted Aug. 10, 1982 to J. W. Williams; or FIG. 4 of U.S. Pat. No. 2,726,683 granted Dec. 13, 1955, all of which are incorporated by reference. In these blinds one end is a solid plate while the other is annular providing an orifice. The blind is inserted between flanged couplings that are bolted together. Gaskets are used to seal the joint and these gaskets maybe on each of opposite faces of the blind or in recesses in each of the flanged couplings.

U.S. Pat. No. 4,271,870 granted Jun. 9, 1981 to J. L. Butler discloses a blind in which a pair of lugs are directed outwardly in opposite directions from a central circular plate. One lug has a hole through which one of the coupling bolt passes and this requires removing that coupling bolt when inserting or removing the blind. The other lug is bifurcated having two spaced apart legs defining a slot therebetween so that the coupling bolt doesn't have to be removed. The legs taper from a narrow thin outer terminal end and gradually increase in thickness in a direction toward the circular member and then decrease in thickness. The tapered ends provide wedges that separate the flanged coupling members as the blind is driven therebetween. The central plate maybe solid as shown in FIG. 2 providing a blind or annular as seen in FIG. 3 providing an orifice.

U.S. Pat. No. 2,386,893 granted Oct. 16, 1945 discloses slots in the flanges of the coupling so that two of the bolts connecting the flanges can be slid outwardly allowing the blind to be inserted without having to remove any of the connecting bolts.

An orifice plate having a single stem projecting therefrom is disclosed in U.S. Pat. No. 4,712,585 granted Dec. 15, 1987 to R. B. Evans and a blind with a pair of opposite outwardly directed lugs is disclosed in U.S. Pat. No. 5,201,344 granted Apr. 13, 1993 to L. A. Lacouture.

The foregoing blinds are either installed in place between the flanged couplings serving as a blind or an orifice in the pipe line or they are stored else where on the premises which in many instances can be considerable distance from where they maybe needed for installation.

It is of course mandatory to install blanks in the lines when they are out of service and the valves or other piping fixtures are removed in order that the lines be sealed as a safety precaution.

### SUMMARY OF THE INVENTION

A principal object of the present invention is to provide a self storing line blind that when not in use is stored and extended from one of the coupling studs without interfering with that coupling.

In keeping with the foregoing there is provided a line blind having a central circular plate for insertion between the flanges of a bolt together flange coupling and a lug projecting outwardly from the circular plate with an opening such as a hole through an outer end portion of said lug through which one of the bolts of the coupling passes and wherein said outer end portion is of lesser thickness than the circular plate and of no greater thickness than the gap between juxtaposed faces of the flanges of the coupling.

The present invention provides for a blind for use in a pipe joint having two flanges bolted together with the juxtaposed faces of the flanges spaced a selected distance from one another. The pipe blind or blank is comprised of a central plate of selected constant thickness and having a stem and a lug radiating outwardly therefrom at a selected angle to one another. The lug is formed having a lesser thickness than the central plate, whereby the thickness is no greater than the selected distance. The lug has a hole for one of the coupling bolts to pass there through of a gap forming an opening between a pair of fingers curved toward one another generally forming a circle or more particularly an oval.

It is an object of the present invention to save labor due to their quick installation and employment.

It is an object of the present invention to provide a permanently mounted isolation blind for refineries, food and beverage factories, and other manufacturing facilities that use slip-blinds during shutdown operations.

In is another object of the present invention to provide an easily insertable blind for use in pipelines which are held in place in shutdowns, but remain attached and out of the way during normal operations.

### BRIEF DESCRIPTION OF THE DRAWINGS

FIG. 1 is an exploded view of a pipeline coupling having a blind of the present invention for blocking the flow through the conduit;

FIG. 2 is an oblique view of a pipeline coupling having a blind of the present invention therein blocking flow through the conduit;

FIG. 3 is an oblique view of the coupling shown in FIG. 2 with the pipe blind in an out of use storage position;

FIG. 4 is a front view of a pipe blind of the present invention shown in FIGS. 2 and 3;

FIG. 5 is right hand side view of the pipe blind of FIG. 4;

FIG. 6 is an alternate embodiment of the pipe blind of the present invention;

FIG. 7 is a right hand side view of the pipe blind shown in FIG. 6;

FIG. 8 is an alternate embodiment of the pipe blind of the present invention;

FIG. 9 is a right hand side view of the pipe blind shown in FIG. 8;

FIG. 10 is an alternate embodiment of the pipe blind of the present invention;

FIG. 11 is a right hand side view of the pipe blind shown in FIG. 10;

FIG. 12 is an alternate embodiment of the pipe blind of the present invention; and

FIG. 13 is a right hand side view of the pipe blind shown in FIG. 12.

### DETAILED DESCRIPTION OF THE INVENTION

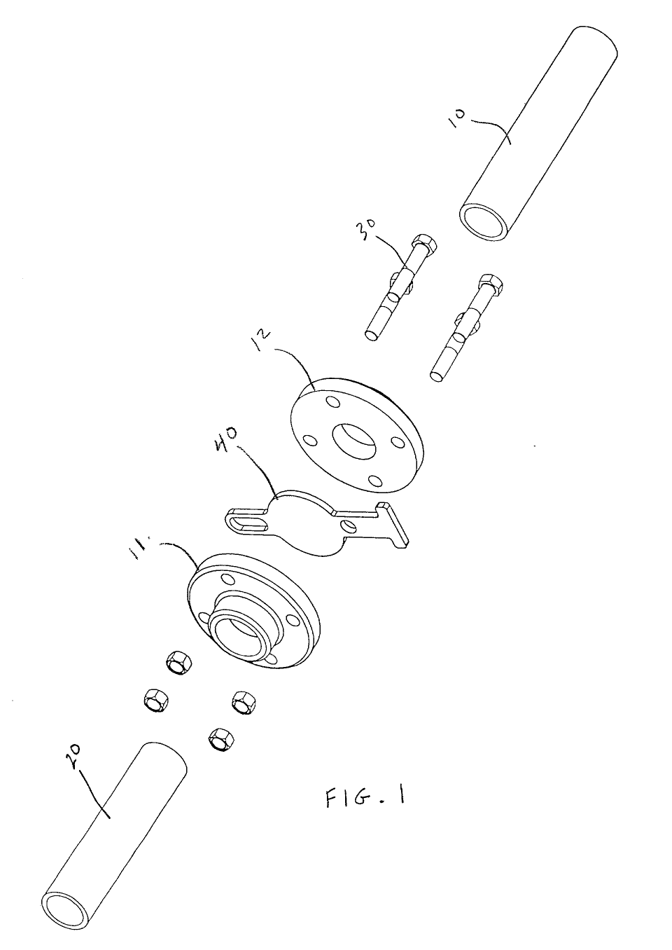

As shown in FIG. 1, the blind or blank 40 is inserted between flanged couplings 11 and 12 respectively, that are bolted together by bolt and nut assemblies 30 holding the distal ends of the pipes 10 and 20 abutting the blind 40 disposed thereinbetween. Gaskets (not shown) can be used to seal the joint and these gaskets maybe on each of opposite faces of the blind 40 or in recesses in each of the flanged couplings 11 and 12.

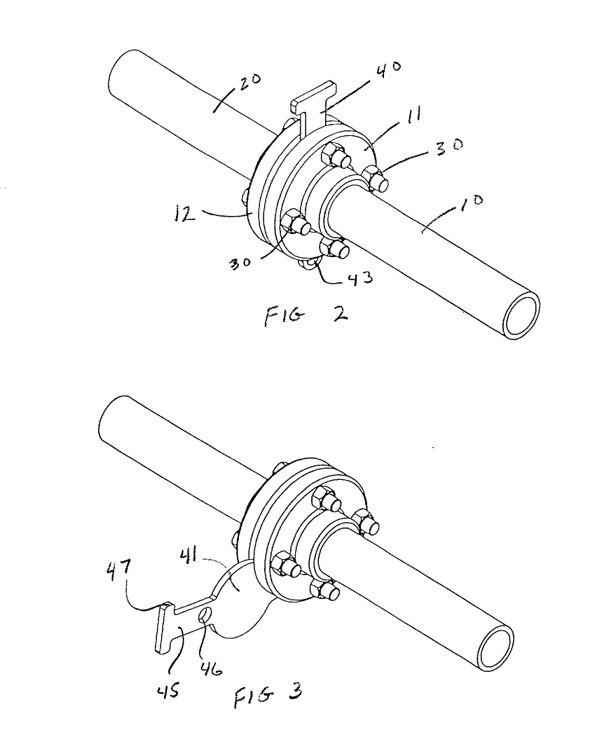

According to FIGS. 2 and 3, there is illustrated in the drawing, portions of two pipe sections 10 and 20 having respective flange coupling members 11 and 21 secured thereto and joined together by four and bolt and nut units 30. The juxtaposed faces of the coupling members 11 and 12 are spaced apart from one another by a gasket compressed between the two pipes 10 and 11 or some other joint sealing means not shown.

In accordance with the present invention there is provided a pipe blind 40 shown in FIG. 2 in a fluid flow blocking position and in FIG. 3 in a not in use storage position. The blind 40 has a central circular plate 41 and a mounting lug 42 radiating outwardly therefrom. The lug has a through hole 43 that is preferably oblong along a radius from the center of the plate as clearly seen in FIG. 3. The lug includes a relief portion that is thinner than the remainder of the plate resulting in a ledge 44 at the juncture of the lug and the circular central portion of the blind. In the preferred embodiments the entire lug is of a decreased thickness as compared to the central circular plate. The lug thickness is no greater than and preferably less than the spacing designated 13 in FIG. 3 between the juxtaposed faces of the coupling members 11 and 12. This gap 13 is with the bolt and nut assemblies 30 tightened sufficiently to provide a leak proof joint. A gasket, or other joint sealing means, is used between the pipe sections as a seal for the joint and in the present invention preferably consists of a gasket member in a recess in each of the juxtaposed flange and/or pipe end faces.

Although it is contemplated that the blinds of the present invention can be made of plastic such as graphite of fiberglass; as a practical matter the blinds or blanks are composed of steel, stainless steel, brass, aluminum, copper, combinations thereof, or some other metal. One preferred embodiment is formed of steel which is coated with a black oxide finish.

By having the lug thickness no greater than and preferably less than the spacing between the adjacent flange faces, i.e. the gap 13, the line blind can remain extending from one of the coupling bolts without interfering with the sealing engagement of the pipe joint. When a piece equipment downstream from the coupling needs servicing one need only loosen the four bolt assemblies 30, remove one of them, separate the joint to provide a gap between the two gaskets that is greater than the major thickness of the blind and swing the blind into position about the bolt by which it is stored until the central plate portion 41 is in a passageway blocking position and then retighten the bolt and nut assemblies.

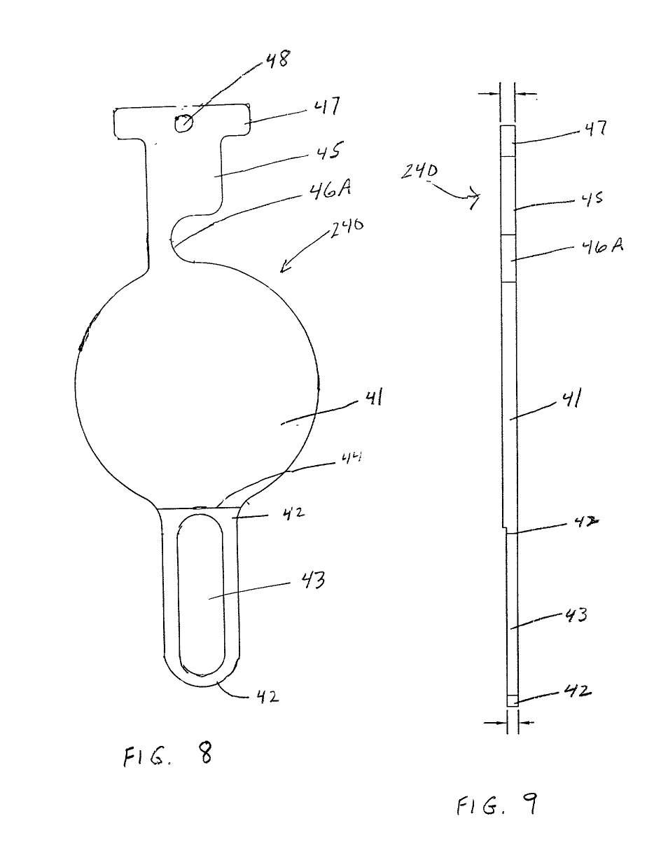

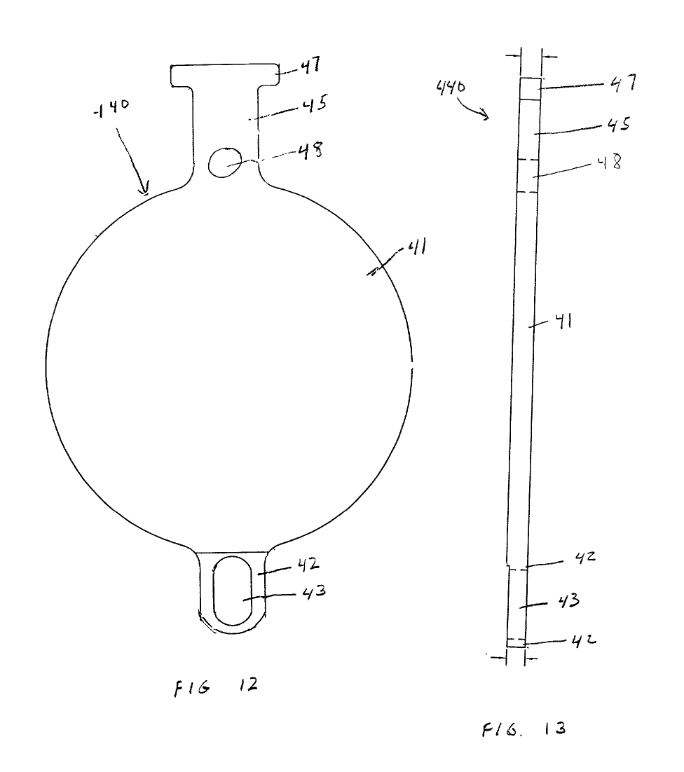

The blind has an elongate stem 45 radiating outwardly from the central plate portion 41. In the embodiment illustrated in FIGS. 1-5, 8-9, and 12-13 the lug 42 and stem 45 are directly opposite one another i.e. radiate outwardly in opposite directions whereby there are 180 degrees apart. The embodiments of FIGS. 1-5 and 12-13 have bores or holes 48 formed in the stem to cooperatively engage a bolt of the flange when pivoted from the storage position to the in-use position as a blank. The embodiment of FIGS. 8-9, utilize a arcuate portion 46A within the stem 45 to slip around a bolt within the flange without having to remove the bolt from the flange upon pivoting the blind 340 around the lug 42 from the storage position to the in use blank position.

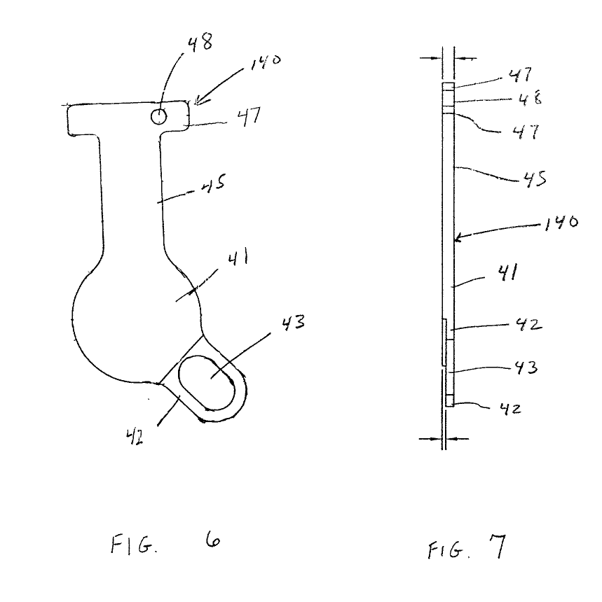

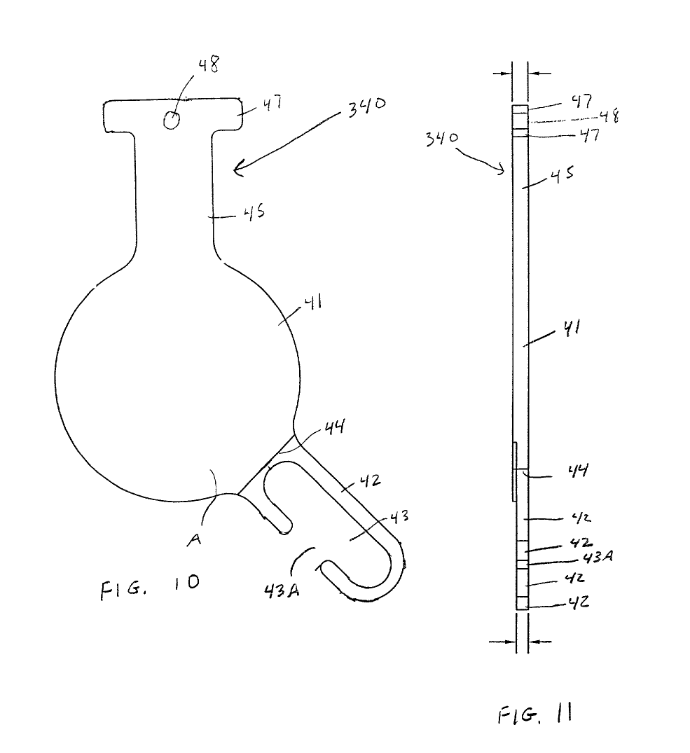

In another preferred embodiment illustrated in FIGS. 6-7 and 10-11 the longitudinal axis of lug 42 radiates outwardly from the center of the circular plate portion 41 and is at an angle of 45 degrees to the longitudinal axis of the stem 45. When the lug 42 is located at an angle of 45 degrees from the stem, the stem is positioned between bolts in the storage position and only one bolt is required to be removed to rotate the blind into position for use. Of course, a hole 48 may be optionally formed in the blind.

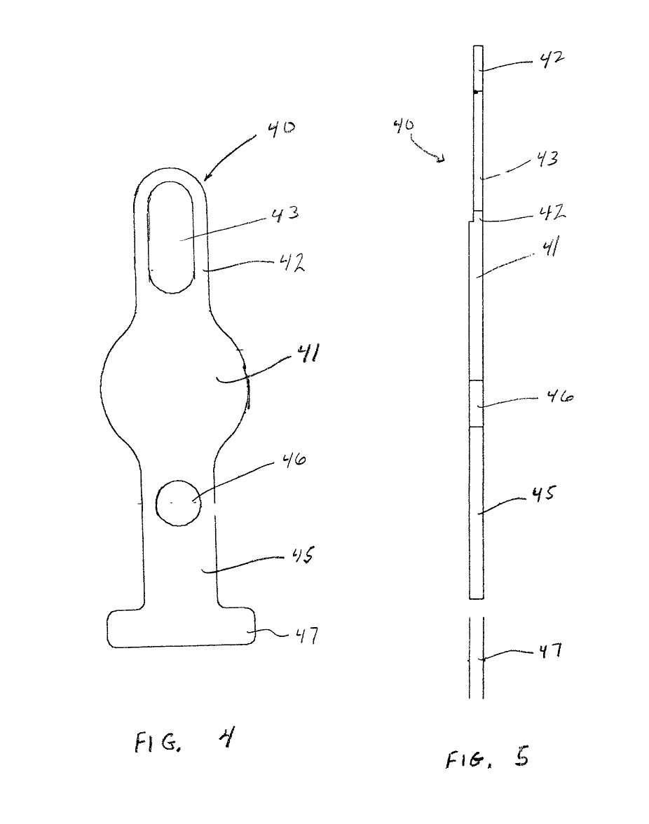

As shown in FIGS. 4-13, the blind has an elongate stem 45 radiating outwardly from the central plate portion 41. The embodiments shown in FIGS. 6-7, 8-9, and 10-11 have stems 45 which include an optional hole 48 located therein. The embodiments shown in FIGS. 4-5, and 12-13 have stems with holes optionally formed within the stem portions closer to the blank central plate portion 41.

The stem 45 of the blind has a through hole 46 for one of the bolts of the bolt and nut assemblies to pass there through when the lug 42 and stem 45 are opposite one another. This through hole is not required in the embodiment illustrated in FIG. 6-7 where the longitudinal axis of the lug 42 is at an angle of 45 degrees to the longitudinal axis of the stem 45. In this embodiment the stem 45 fits between two adjacent bolts of the coupling. Irrespective of the relative orientation of the lug 42 and the stem 45 the lug 42 is of lesser thickness than the remainder of the blind which is of constant thickness. By way of example the width of the stem 45 and lug 42 may each be up to 1 inch, the central plate up to 2.13 inches in diameter, the plate thickness up to 0.19 inches and the lug 42 thickness up to 0.10 inches.

The stem 45 terminates at it outer end in a “T” portion 47 and in which there is a small hole 48.

The pipe blind shown in FIG. 5 is the same as shown in FIGS. 1 and 2 except for a notch 46A in the stem in place of the hole 46. With this notch it is unnecessary to remove the coupling bolt that passes through the hole in the stem as is the case with the embodiment of FIGS. 1 and 2.

FIG. 6 illustrates a modification to the embodiment shown in FIG. 3 differing therefrom by a notch 43 that extends into the elongate hole 43 in the lug 42. With this embodiment none f the bolts have to be removed in order to insert the blind into a coupling.

While particular embodiments of the invention have been shown and described, it should be understood that the invention is not limited thereto, since many modifications are possible within the scope of the appended claims. The foregoing detailed description is given primarily for clearness of understanding and no unnecessary limitations are to be understood therefrom, for modifications will become obvious to those skilled in the art based upon more recent disclosures and may be made without departing from the spirit of the invention and scope of the appended claims.

I claim:

1. A blind for use in a pipe joint having two flanges bolted together with the juxtaposed faces of the flanges spaced a selected distance from one another comprising a central plate of selected constant thickness and having a stem and a lug radiating outwardly therefrom at a selected angle to one another, said lug being of lesser thickness than said central plate and with the thickness no greater than said selected distance, said lug having a hole for one of the coupling bolts to pass there through.

2. The pipe blind as defined in claim 1 wherein said central plate is circular.

3. The pipe blind as defined in claim 2 wherein said lug and stem radiate outwardly in opposite directions from said central plate and wherein said stem has a hole there through for another one of the coupling bolts to pass there through.

4. The pipe blind as defined in claim 2 wherein said stem and lug radiate outwardly at a selected angle of 45 degrees to one another.

5. The pipe blind as defined in claim 2 wherein said lug is disposed at an angle of 45 degrees to a longitudinal axis of said stem.

6. The pipe blind as defined in claim 3, including a notch extending inwardly from an edge of said stem into said hole in said stem.
